(19) United States
(12) Patent Application Publication
(10) Pub. No.: US 2016/0169583 A1
(43) Pub. Date: Jun. 16, 2016

(54) STEAM CONDENSATION TOWER FOR A GRANULATION INSTALLATION

(71) Applicant: PAUL WURTH S.A., Luxembourg (LU)

(72) Inventors: Horst KAPPES, Trier (DE); Marc SCHWEITZER, Mamer (LU); Tommy MATHIEU, Clemency (LU)

(73) Assignee: Paul Wurth S.A., Luxembourg (LU)

(21) Appl. No.: 14/902,836

(22) PCT Filed: Jun. 27, 2014
(86) PCT No.: PCT/EP2014/063712

§ 371 Date: Jan. 4, 2016

(30) Foreign Application Priority Data
Jul. 1, 2013 (LU) 92 235

(51) Int. Cl. F27D 15/02; C21B 7/10; C21B 3/08

(52) U.S. Cl. CPC F27D 15/0286; C21B 3/08; C21B 7/10

(57) ABSTRACT

The present invention concerns a granulation installation (10) for granulating molten material produced in a metallurgical plant. The installation comprises a.o. a steam condensation tower (30) with a steam condensing system and an evacuation device (60) for selectively evacuating gas and steam from said tower, condensing excessive steam and evacuating gas to the atmosphere, said evacuation device (60) having an inlet (62) arranged to communicate with said upper zone (44) of said condensation tower (30) above the water-spraying device (40) and an outlet arranged to evacuate and condensate steam and evacuate gas from said condensation tower (30).

### TECHNICAL FIELD

The present invention generally relates to a granulation installation for molten material, especially for metallurgical melts such as blast furnace slag. It relates more particularly to an improved steam condensation tower design for use in such an installation.

### BACKGROUND ART

An example of a modern granulation installation of this type, especially for molten blast furnace slag, is illustrated in appended FIG. 2 that is part of a paper entitled “INBA® Slag granulation system—Environmental process control” published in Iron&Steel Technology, issue April 2005. As seen in FIG. 2, this kind of installation typically comprises: a water injection device [2] (also called blowing box), for injecting granulation water into a flow of molten material, e.g. slag that is received via a runner tip [1]. Thereby, granulation of the molten material is achieved. The installation further has a granulation tank [3] for collecting the granulation water and the granulated material and for cooling down the granules in a large water volume beneath the water injection device [2]. A steam condensation tower, typically having a cylindrical shell closed by a top cover, is located above the granulation tank for collecting and condensing steam generated in the granulation tank. In fact, due to the high temperatures of the molten material and the huge amount of quenching water required, a considerable amount of steam is typically produced by installations according to FIG. 2. To avoid pollution by simple emission of steam into the atmosphere, the steam condensation tower includes a steam condensing system, typically of the counter-current type. The steam condensing system has a water-spraying device [5] for spraying water droplets into steam that rises inside the steam condensation tower and a water-collecting device [6] located below the water injection device [5], for collecting sprayed condensing droplets and condensed steam.

Production of molten material in metallurgical processes is typically cyclic and subject to considerable fluctuations in terms of produced flow rates. For instance, during a tapping operation of a blast furnace, the slag flow rate is far from being constant. It shows peak values that may be more than four times the slag flow rate averaged over the duration of the tapping operation. Such peaks occur, occasionally or regularly, during short times, e.g. several minutes. It follows that in a typical state-of-the art water-based granulation installation, there are important fluctuations in the incoming heat flow rate due to the incoming slag, accordingly, equivalent fluctuations in the amount of steam generated over time. In order to find a suitable compromise between installation size and costs, the steam condensation capacity is often not designed to handle the full steam flow, which might be generated during peak slag flows. Overpressure relief flaps are foreseen (as seen in the top cover shown in FIG. 2) to open in such cases, in order to evacuate excessive steam to the atmosphere.

However, observation has shown that, in practice, such overpressure flaps do not always reliably open at excess melt flow rates. It is theorized that steam is partially blocked from leaving through the overpressure flaps because, among others, of the “barrier” formed by the “curtain” of water constantly produced by the water injection device [2]. Possibly, at high steam rates, there is also resistance to steam flow formed by the water-collecting device [6]. Accordingly, excess steam remains inside the tower, and overpressure is subsequently generated. This can lead to partial backflow of steam at the lower inlet of the condensation tower, at the entrance of the granulation tank [3]. An internal hood is especially foreseen to separate the inside from the outside, and thus avoiding unwanted air to enter the tower and also preventing steam from being blown out of the tower.

Such reverse steam flow may lead, at the very least, to bad visibility in the casthouse, which is obviously a serious safety risk for operating personnel. Much more adversely, steam blowing back through the internal hood can lead to considerable generation of low-density slag particles (so-called “popcorn”) when the steam comes into contact with the liquid hot melt inside the slag runner spout. Such hot particles, when projected into the casthouse, generate an even more severe safety risk.

WO2012/079797 A1 addresses this problem as well and proposes to selectively evacuate the excess steam via a stack to the atmosphere. This stack has an inlet communicating with the lower zone of the condensation tower and an outlet arranged to evacuate steam to the atmosphere above the condensation tower. Furthermore, the stack is equipped with an obturator device for selective evacuation of steam through the stack.

EP 0 573 769 A1 discloses a process in which a mixture of steam and polluted air is first channeled into an ascending flow (19) into an condensation tower and that then the mixture flows in a descending flow into an enclosure maintained under partial vacuum. An aqueous alkaline solution is sprayed in a parallel flow into the said descending flow and the decontaminated non-condensed gases are discharged from the enclosure by a forced and adjustable stream, which creates and maintains a partial vacuum inside the said enclosure. A device for the implementation of the said process is also described.

### BRIEF SUMMARY

A steam condensation tower is provided which enables more reliable evacuation of excessive steam during granulation at peak flow rates, while being compatible with existing granulation plant designs at comparatively low additional cost.

A condensation tower is further provided that enables reduction in installation and operating costs of the plant.

In order to overcome the above-mentioned problem, the present invention proposes an evacuation device, for selectively evacuating and condensing excessive steam from the condensation tower. The evacuation device according to the invention has an inlet arranged to communicate with the upper zone of the condensation tower above the water-spraying device and an outlet arranged to release entirely condensed steam. As opposed to the device of WO2012/079797 A1, this evacuation device not only evacuates the excess steam and vapors from the condensation tower but it also condenses the evacuated steam and vapors so that the impact on the environment is greatly reduced. Indeed these vapors may contain sulfur components like H₂S and the like which will be dissolved in water in the present invention.

It has been found that during the granulation of slag, hydrogen gas may be formed under some circumstances. Indeed, the hot liquid slag may contain iron and, in contact with the hot iron contained in the slag, water molecules may be split up into hydrogen and oxygen. This hydrogen gas is extremely explosive and since the condensation tower is basically air tight, the hydrogen gas, which is much lighter than air, may accumulate in the upper zone of the condensation tower. Under specific circumstances, this mixture may ignite and an explosion or a fire may be the consequence. Calculations have shown that during a granulation run, the hydrogen production may vary between about 0.5 m³ H₂ /min and 8 m³ H₂/min, depending on the iron content of the slag and the diameter of the granules produced.

The installation as described in WO2012/079797 A1 may in some instances not be suitable to eliminate this risk of fire or explosion, since the inlet of the stack is situated in the lower zone of the condensation tower and the hydrogen gas being lighter than air will inevitably accumulate in the upper zone of the condensation tower and will thus not be evacuated by the device as described in WO2012/079797 A1.

The same is true for the device described in EP 0 573 769 A1, since the non condensed gases are evacuated from a lower zone of the condensation tower. Hydrogen gas, being extremely light, will accumulate in the upper part of the condensation tower and is therefore not evacuated effectively since the evacuation device is situated too low in the condensation tower, below the water-spraying device. Furthermore, the present condensation tower does not require an enclosure, which is maintained under partial vacuum to be built inside the condensation tower, in which the gases flow in a descending flow while they are condensated by a water-spraying device. The present condensation tower is therefore less expensive and more reliable.

The present device does not impair the performance of the tower when the evacuation device is not in use. Indeed, contrary to the device described in EP 0 573 769 A1, the tower and its cooling/condensation capacity is not impaired by a large device installed inside the tower, which inevitably reduces the surface/volume where the water spraying device and the water collecting device operate. With the evacuation device described above, the useful volume of the tower is not affected since the evacuation device is installed outside of the shell of the tower. Even if the device would be installed inside the tower, since it is installed above the water spraying device/nozzles it does not affect the condensation performance of the water spraying device.

The evacuation device is therefore especially useful in retrofitting condensation towers and thus useful to easily boost the granulating capacity of an existing slag granulation plant.

In order to permit selective evacuation as desired or required, the evacuation device is preferably equipped with any suitable device for controlling the flow rate of steam and/or gas through the evacuation device.

Preferably, the evacuation device comprises a vacuum pump and in particular an eductor-jet pump, that produces vacuum by means of the Venturi effect. Such an eductor-jet pump is a type of pump that uses the Venturi effect of a converging-diverging nozzle to convert the pressure energy of a motive fluid to velocity energy which creates a low pressure zone that draws in and entrains a suction fluid. After passing through the throat of the injector, the mixed fluid expands and the velocity is reduced which results in recompressing the mixed fluids by converting velocity energy back into pressure energy. In this particular case, the motive fluid is water and the entrained suction fluid is steam and/or a mixture of steam and hydrogen gas. During the operation of the pump, the evacuated steam is condensed and mixed with the water that drives the pump. Any sulfurous compounds contained in the steam will be dissolved and neutralized in the water as well. Calculation showed that about 385 I of water are needed to dissolve H₂S contained in one 1 t steam and about 142 I are needed to dissolve the complete SO₂ contained in one 1 t steam.

The proposed evacuation device has the incontestable merit of safely evacuating any undesired and potentially harmful excess of steam and hydrogen from the granulation plant and thereby considerably increasing operation safety. Moreover, the proposed evacuation device allows to condensate the evacuated steam and to dissolve and neutralize the sulfur containing compounds in water, thus reducing the environmental effect of the plant.

A further advantage of the above-described device is that the installation may be designed with a smaller-scale condensation system. In fact, an installation equipped with the proposed evacuation device is capable of handling a total steam flow corresponding to a higher slag flow rate, the steam flow being composed of one partial steam flow, typically of larger proportion, that is condensed in usual manner and another partial steam flow, typically of minor proportion, that is evacuated from the condensation tower through the proposed evacuation device during a limited time. Hence, instead of adopting common practice of designing the entire installation for the maximum expected melt flow rate and steam volume, it may be designed to handle a lower nominal flow rate occurring during the majority of time during operation. Considerable savings in capital and operating expenditure are thereby enabled. As will be further appreciated, the evacuation device design avoids overpressure inside the condensation tower and, safely precludes steam from being blown back into the casthouse at higher-than-nominal flow rates. By virtue of selective evacuation only, the installation operates in conventional manner at nominal and lower-than-nominal flow rates, without steam being purposely evacuated from the condensation tower. Furthermore, the investment (capital expenditure) for providing the proposed evacuation device are very low compared to increasing the capacity of the condensation system up to a comparable safety margin.

Preferred embodiments of the installation are defined in dependent claims 2 to 15. As will be understood, while not being limited thereto, the proposed installation is especially suitable for a blast furnace plant.

### BRIEF DESCRIPTION OF THE DRAWINGS

Further details and advantages of the present invention will be apparent from the following detailed description of several not limiting embodiments with reference to the attached drawings, wherein:

FIG. 1 is a block schematic diagram of an embodiment of a granulation installation equipped with a steam condensation tower according to the invention;

FIG. 2 illustrates a known granulation installation according to prior art.

Identical reference signs are used throughout the drawings to identify structurally or functionally similar elements.

### DESCRIPTION OF PREFERRED EMBODIMENTS

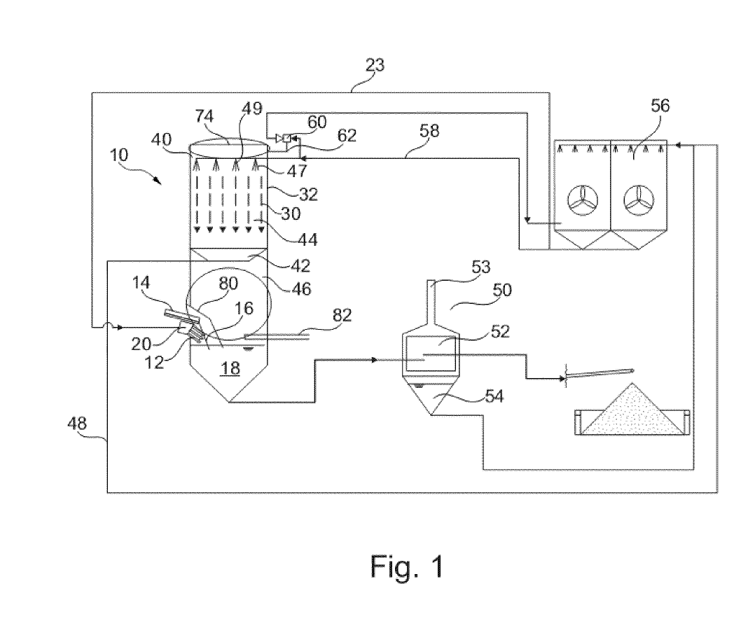

For illustrating an embodiment of the present invention, FIG. 1 shows a diagrammatic view of a granulation installation 10 designed for slag granulation in a blast furnace plant (the plant not being shown). Generally speaking, the installation 10 thus serves to granulate a flow of molten blast furnace slag 14 by quenching it with one or more jets 12 of comparatively cold granulation water. As seen in FIG. 1, a flow of molten slag 14, inevitably tapped with the pig iron from a blast furnace, falls from a hot melt runner tip 16 into a granulation tank 18. During operation, jets of granulation water 12, which are produced by a water injection device 20 (often also called a “blowing box”) supplied by one or more parallel high-pressure pump(s) (not shown), impinge onto the molten slag 14 falling from the hot runner tip 16. A suitable configuration of a water injection device 20 is e.g. described in patent application WO 2004/048617. In older granulation installations (not shown, but encompassed), molten slag falls from a hot runner onto a cold runner, with jets of granulation water from a similar water injection device entraining the flow on the cold runner towards a granulation tank. Irrespective of the design, granulation is achieved when the granulation water jets 12 impinge on the flow of molten slag 14.

By virtue of quenching, the molten slag 14 breaks up into grain-sized “granules”, which fall into a large water volume maintained in the granulation tank 18. These slag “granules” completely solidify into slag sand by heat exchange with water. It may be noted that the jets of granulation water 12 are directed towards the water surface in the granulation tank 18, thereby promoting turbulence that accelerates cooling of the slag.

As is well known, quenching of an initially hot melt (>1000° C.) such as molten slag results in important quantities of steam (i.e. water vapour). This steam is usually contaminated, among others, with gaseous sulfur compounds. In order to reduce atmospheric pollution, steam released in the granulation tank 18 is routed into a steam condensation tower 30 that is typically located vertically above the granulation tank 18. This steam condensation tower 30 (hereinafter in short “tower 30”) is equipped with a steam condensing system, usually of the counter-current type, that includes a water-spraying device 40 and a water-collecting device 42. As seen in FIG. 1, the tower 30 is a comparatively large edifice that has an external shell 32. The shell 32, which is typically but not necessarily a cylindrical welded steel plate construction, is provided with a top cover 34. The tower 30 has a certain height and diameter dimensioned for a nominal volume of emitted steam.

The water-spraying device 40 is usually located near the top cover 34 of the tower 30 for maximum effect. It includes a plurality of water-spraying nozzles 47, 49 for spraying water droplets into steam and vapors that rise inside the tower 30. The water-spraying device 40 serves steam condensation and additionally improves dissolution of harmful gases such as sulfur containing gases.

The water-collecting device 42 is arranged inside the tower 30 at a vertical distance of several meters below the water-spraying device 40. The water-collecting device 42 can be seen to divide the tower 30 into a virtual upper zone 44, in which steam condenses during operation, and a virtual lower zone 46. During operation, steam rises from the granulation tank 18, through the lower zone 46 and the water-collecting device 42, into the upper zone 44. Typically, the upper zone 44 occupies a significantly larger height proportion than the lower zone 46. In FIG. 1 the full height of the tower 30 is not shown, i.e. the vertical distance between the water-spraying device 40 and the water-collecting device 42 is typically greater than illustrated in FIG. 1.

The water-collecting device 42 is configured to collect the falling droplets, resulting from the sprayed droplets and condensed steam. The water-collecting device 42 thereby prevents water from falling back into the granulation tank 18 and permits recovery of comparatively clean process water by way of a drainage conduit 48. For this purpose, the water-collecting device 42 can include at least one funnel-shaped or cup-shaped upper collector and a lower funnel-shaped collector In this case, several circumferentially distributed openings between the collectors allow steam and vapors to rise from the lower zone 46 into the upper zone 44 of the tower 30. To minimize flow resistance offered to the steam, the distributed openings between the collectors preferably have a height of at least 500 mm. Other designs of a water-collecting device 42 are possible and encompassed.

As seen in FIG. 1, at the bottom of the granulation tank 18, solidified slag sand mixed with granulation water is evacuated. The mixture (slurry) is fed to a dewatering unit 50. The purpose of this dewatering unit 50 is to separate granulated material (i.e. slag sand) from water, i.e. to enable separate recovery of slag sand and process water. A suitable general configuration of a dewatering unit 50 is well known from existing INBA® installations or described e.g. in U.S. Pat. No. 4,204,855 and thus not further detailed here. Such a dewatering unit comprises a rotary filtering drum 52, e.g. as described in more detail in U.S. Pat. No. 5,248,420. Any other static or dynamic device for dewatering fine solidified melt granules may also be used. As further shown in FIG. 1, a granulation water recovery tank 54 (often called a “hot water tank”) is associated with the dewatering unit 50 for collecting water that is separated from the granulated slag sand. In most cases, this water recovery tank 54 is conceived as a settling tank with a settling compartment and a clean water compartment (not shown), into which the largely sand-free (“clean”) water overflows.

As also appears from FIG. 1, the drainage conduit 48 of the water-collecting device 42 can be connected to feed condensed and sprayed water from tower 30 directly to a cooling system 56 that has one or more cooling towers. Alternatively, it may be pumped into the water recovery tank 54 or be used for other purposes, e.g. to feed the injection device(s) 20, or simply be discarded. In case the water from the collecting device 42 is fed into the clean water compartment of the water recovery tank 54, it is pumped from this compartment, which is largely solids-free water to the cooling system 56.

Cooled process water from the cooling system 56 is fed back to the granulation installation 10 for reuse in the process. More specifically, cold water is preferably fed, on the one hand, to the water injection device 20 via one supply conduit 23 and, on the other hand, to the water-spraying device 40 via another supply conduit 58. The supply conduit 23 is equipped with the aforementioned pump(s). The supply conduit 58 in turn is equipped with at least one pump (not shown), or preferably two parallel pumps, that belong to the water-spraying device 40. Accordingly, the water-spraying nozzles 47, 49 of the water-spraying device 40 are supplied with re-circulated cold water from the cooling system 56 via the supply conduit 58. Whereas such a “closed-circuit” configuration for process water is preferred, open-circuit alternatives are also encompassed, with water supplied to the water-spraying nozzles 47, 49 and or the injection device(s) 20 being disposed after use.

According to an aspect to be appreciated, the tower 30 according to the invention is equipped with an evacuation device 60 for evacuating excessive steam and gas from the tower 30. The evacuation device 60, as schematically illustrated in FIG. 1, is a vacuum pump that is operatively associated to the tower 30. More specifically, the evacuation device 60 illustrated in FIG. 1 has a inlet 62 arranged to communicate with the upper zone 44 of the tower 30 so that the vacuum created by the evacuation device 60 will evacuate any gases and/or steam contained in the upper zone 44 of the tower 30.

Such an evacuation device 60 preferably comprises a vacuum pump also called eductor-jet pump, which utilizes the kinetic energy of one liquid to cause the flow of another and operate on the basic principles of flow dynamics. Eductor-jet pumps comprise a converging nozzle, a body and a diffuser and resemble syphons in appearance. In operation, the pressure energy of the motive liquid is converted to velocity energy by the converging nozzle. The high velocity liquid flow then entrains the suction fluid. Complete mixing of the motive liquid and suction fluid is performed in the body and diffuser section. The mixture of liquid/fluid is then converted back to an intermediate pressure after passing through the diffuser.

The inlet 62 of the evacuation device 60 is preferably situated between the water-spraying device 40 and the top cover 34 of the tower 30.

Although on FIG. 1 there is depicted only one evacuation device 60, it is understood that a plurality of such evacuation devices may be installed on the tower 30. Such a plurality of evacuation devices 60 may for example be installed in ring around the top of the tower 30 i.e. in the same horizontal plane.

Furthermore, a plurality of evacuation devices 60 may be installed in a vertical plane i.e. one above the other, or in rows one above the other around the upper zone 44 of the tower 30. In such a case, the inlet 62 of some of the evacuation device 60 may be situated between the water-spraying device 40 and the water collecting device 42 of the tower 30.

It has to be noted that the inlet of the ejector is in the upper zone of the condensation tower, the ejector itself can even be placed on ground level, which has the advantage that less water pressure is required to operate it.

With an arrangement as shown in FIG. 1, the evacuation device 60 can be readily supported by the structure of the external shell 32 and/or, if desirable, partially or fully suspended to the structure of the top cover 34.

In the embodiment shown on FIG. 1, the evacuation device is situated outside the tower, but is clear that such a evacuation device(s) 60 may also be installed inside the tower.

The evacuation device 60 is connected to the supply conduit 58 of the water-spraying device 40 of the tower 30 and a part of the water in that supply conduit 58 is used to drive the evacuation device 60 and create a vacuum to evacuate the steam and gases contained in the upper zone 44 of the tower 30 and condensate the steam and mix the condensed steam and gas with the water used to drive the evacuation device 60. For a small system, about 10-20 m³/h of water at a pressure of about 4 bar may be needed. For a larger system, up to about 300 m³/h at about 4 bar may be needed.

Specifically, as will become more apparent below, the evacuation device 60 enables evacuation and condensation of amounts of steam in excess of the condensation capacity of the tower 30 as well as the evacuation of any undesired gases like hydrogen from the tower 30, because it is situated above the water-spraying device 40, i.e. between the top cover 34 and above the water-spraying device 40. As the evacuation device 60 does not require any electricity nor contain any moving parts, the risk of creating sparks or hot surfaces is absent and the risk of fire or explosion is thus eliminated.

Furthermore, as the evacuation device 60 does not require any electricity, the installation of such a device to the tower 30 is readily achieved at low costs.

As will be understood, appropriate dimensioning respectively the number of the evacuation device(s) 60 determines the amount of steam and gas that can be safely evacuated through the evacuation device 60 (without overpressure in the upper zone 44 of the tower 30 and the related risk of steam backflow). In case of an installation 10 designed for blast furnace slag, a corresponding evacuation device 60 readily achieves a flow capable of evacuating and compensating steam generated by extra slag in the order of 3-4 t/min (excess flow rate) By virtue of the evacuation device 60, the installation 10 can thus safely operate at slag flow rates higher than the maximum condensation capacity of the tower 30. For instance, it may operate at peak slag flow rates of 11-12 t/min with a tower 30 designed for condensing steam generated by melt flow rates of only 8 t/min. As will be appreciated, an evacuation device 60 according to the invention thereby allows processing capacity increases of up to 50% while also increasing the safety of operation. The production of steam for 1-2 t/min however would be handled with three medium sized ejectors, consuming about 500-600 m³/h of water.

The flow rate of gas/steam evacuated from the tower 30 via the evacuation device 60 directly depends on the flow rate and the pressure of the water used to drive the evacuation device 60. A control device like a valve (not shown) regulating the flow and/or the pressure of the water used to drive the evacuation device 60 may thus be used to regulate the flow rate of gas/steam evacuated from the tower 30.

The water from the conduit 58 that is used to drive the evacuation device 60 is mixed inside the evacuation device 60 with the steam evacuated from the tower 30. The steam condenses and any gases evacuated will be dissolved at least partially in the water and evacuated towards the cooling system via evacuation conduit 59. Other parts of the plant could be used for the water/H₂ release. In this particular case as depicted in FIG. 1, the evacuation conduit 59 leads the water from the evacuation device 60 to the bottom part of the cooling system 56. In other embodiments, the conduit 59 could also be connected to the drainage conduit 48 and be transported to the cooling system 56 together with the water from the water-cooling device 42. This allows evacuating any hydrogen gas from the tower 30 to a location, which is situated at a large distance from the granulation installation, so that the fire and explosion hazard in the granulation installation is eliminated.

In order to warrant efficient condensation and minimum pollution at usual flow rates below peak values, the evacuation device 60 of FIG. 1 is equipped with the aforementioned control device. This control device serves to “shut-off” the evacuation device 60, i.e. to close or at least significantly restrict the flow rate of the water used to drive the evacuation device 60 whenever the granulation installation 10 operates at or below nominal flow rates, especially with steam generated at or below the condensation capacity of the tower 30. In other words, the control device 70 is used to evacuate steam through the evacuation device 60 selectively only when required or desired in function of the actually generated steam quantity and/or in function of the hydrogen content / concentration in the upper zone of the tower 30.

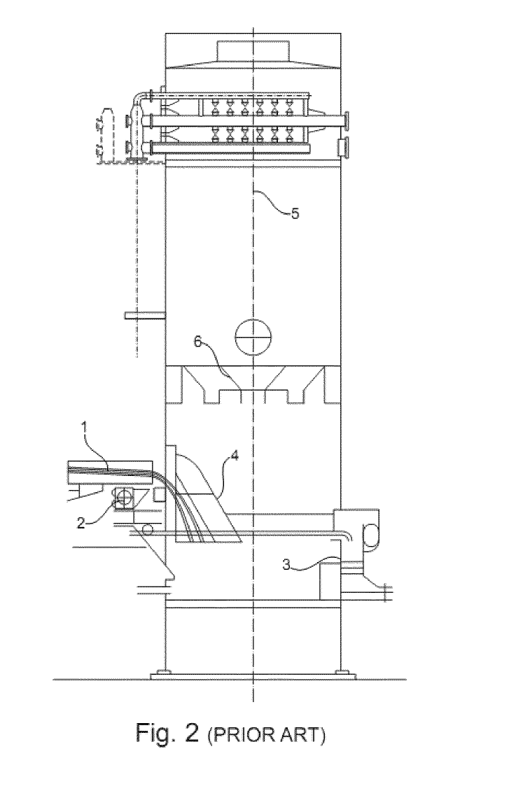

In a conventional system, as illustrated in FIG. 2, whenever melt flow rates exceed the capacity of the tower 30, experience has shown a severe risk of backflow (reverse flow) of steam, e.g. into the hot runner and even into the casthouse (not shown) upstream of the runner tip 16. Even with overpressure flaps in the top cover 34 and with an internal hood 80, as illustrated in FIG. 1, achieving a certain resistance against backflow, backflow can still occur. In known manner, the internal hood 80 (shown in FIG. 2) is provided mainly for sealing the tower 30 against entry of “false” ambient air.

Contrary to such conventional design, the proposed evacuation device 60 provides a reliable solution for safely evacuating and compensating excess steam whenever flow rates exceed the nominal capacity of the tower 30. As will be understood, such excess flow rates may occur accidentally, e.g. in case of molten slag peaks because of a problem at the taphole of the blast furnace. As will be appreciated, by virtue of the present invention, designs with lower plant capacity in terms of steam condensation can be considered. In fact, with a nominal capacity designed to be less than the expected short-term flow rate peaks, i.e. contrary to accepted design practice (with nominal capacity corresponding to expected peak flow) a tower 30 equipped with a evacuation device 60 may still reliably operate.

As opposed to the device described in WO2012/079797 A1, the present device does not impair the performance of the tower 30 when the evacuation device 60 is not in use. Indeed, contrary to the device described in WO2012/079797 A1, the tower 30 and its cooling/condensation capacity is not impaired by the a large device installed inside the tower 30, which inevitably reduces the surface/volume where the water spraying device 40 and the water collecting device 42 operate. With the evacuation device 60 described above, the useful volume of the tower 30 is not affected since the evacuation device 60 is installed outside of the shell of the tower. Even if the device would be installed inside the tower 30, it may be installed above the water spraying device/nozzles and thus not affect the condensation performance of the water spraying device 40. The evacuation device 60 is therefore especially useful in retrofitting condensation towers and thus useful to easy to boost the granulating capacity of an existing slag granulation plant.

Similar evacuation devices may be used to serve additional evacuation purposes. In particular, the dewatering unit 50 has a steam collection hood 53 above the dewatering drum 52. One or more evacuation devices (not shown) may be installed so as to suck off steam and gas from the dewatering unit 50 and/or from the steam collection hood 53. This configuration has the benefit of properly evacuating steam and gas from the dewatering unit 50 and condensing the steam and thus reducing visibility problems in the surroundings of the dewatering unit 50 and the installation 10′ in general.

Similarly, a further evacuation device (not shown) may be connected with its intake to the internal hood 80. This measure transforms the internal hood 80 into an extraction hood. A certain draught is created in the space delimited by the internal hood 80 above the hot runner tip 16 and the jets 12. This measure provides additional safety, by avoiding backflow of that fraction of steam that is generated by the jets 12 into the runner and into the casthouse and by evacuating any hydrogen gas from the places where there are products with high temperatures or sparks.

Preferably, the evacuation device(s), is (are) connected to a controller, which can be integrated into the process control system of the entire plant. The controller operates a remote controllable automatic valve connected to the outlet of the pump that feeds the evacuation device(s) 60. Accordingly, by controlling opening and closure of the valve, the controller controls operation of the evacuation device(s) 60 so as to selectively restrict or permit steam and gas passage through the evacuation device.

According to one embodiment, a steam-injecting device such as a steam injection lance 82 is provided in the lower zone 46 of the condensation tower 30. This device will inject steam in the lower zone 46 of the condensation tower shortly before the casting of slag is started (500-1000 m³/h). Indeed, it has been found that at the beginning of the slag casting, the water contained in the granulation tank 18 is cold and therefore the quantity of steam produced is relatively low and increases only after a certain quantity of slag has been granulated and the water in the granulation tank 18 has heated up to about 80° C. Furthermore, it has been found that if the slag contains iron, significant quantities of hydrogen gas can be generated. During the beginning of the granulation run, the hydrogen gas is particularly dangerous because very little steam is generated during that period. It is however known that, if the atmosphere contains steam, the risk of explosion of a mixture air/hydrogen is limited. The steam-injecting device 82 will thus help to significantly lower the fire and explosion hazard during the start of the slag casting while the water in the granulation tank 18 is still cold.

In conclusion, it will be appreciated that the present invention not only enables an important increase in operational safety of a water-based granulation installation 10, especially for blast furnace slag. In addition, the invention permits reliable operation at reduced condensation capacity and thus at lower capital and operating expenditure. In fact, in case of a blast furnace slag granulation installation, it is projected that a granulation installation 10 with the proposed evacuation device 60; 60′ is capable of reliably processing an excess of steam that corresponds to an increase of slag flow of up to +25%. This may represent an increase of for instance around +2 t/min (83.33 kg/s) of slag in a system having a condensation capacity designed to handle a maximum slag flow rate of 8 t/min (133.33 kg/s).

1. A granulation installation for granulating molten material produced in a metallurgical plant, said installation comprising:
a water injection device, for injecting granulation water into a flow of molten material and thereby granulating the molten material;
a granulation tank for collecting the granulation water and the granulated material;
a steam condensation tower located above said granulation tank, for collecting steam generated in said granulation tank, said steam condensation tower having an external shell with a top cover and a steam condensing system that includes
a water-spraying device for spraying water droplets into said steam condensation tower, and
a water-collecting device located in said steam condensation tower below said water-spraying device, for collecting sprayed water droplets and condensed steam;
said collecting device dividing said tower into an upper zone, in which steam can condense, and a lower zone through which steam can rise from said granulation tank into said upper zone;
the installation further comprising:
an evacuation device for selectively evacuating gas and steam from said tower, condensing excessive steam and evacuating gas to the atmosphere, said evacuation device having an inlet arranged to communicate with said upper zone of said condensation tower above the water-spraying device and an outlet arranged to evacuate and condensate steam and evacuate gas from said condensation tower.

2. The granulation installation as claimed in claim 1, wherein said evacuation device is equipped with a device for controlling selective evacuation of steam through said evacuation device, in with a regulation device for regulating a flow rate of the evacuation device.

3. The granulation installation as claimed in claim 1, wherein said evacuation device comprises an eductor-jet pump that produces vacuum by means of the Venturi effect.

4. The granulation installation as claimed in claim 1, wherein the inlet of the evacuation device is situated between the water-spraying device and the top cover of the tower.

5. The granulation installation as claimed in claim 1, wherein the inlet of the evacuation device is situated between the water-spraying device and the water collecting device of the tower.

6. The granulation installation as claimed in claim 1, wherein said evacuation device is arranged outside said condensation tower.

7. The granulation installation as claimed in claim 1, wherein said evacuation device is supported by said external shell and/or said top cover of said condensation tower.

8. The granulation installation as claimed in claim 1, wherein said evacuation device is connected to a water supply conduit of the water-spraying device of the tower.

9. The granulation installation as claimed in claim 1, wherein said evacuation device comprises a control device regulating the flow and/or the pressure of the water used to drive the evacuation device

10. The granulation installation as claimed in claim 1, wherein said gas and condensated steam are evacuated towards a cooling system.

11. The granulation installation as claimed in claim 1, further comprising a sensor measuring hydrogen content and/or steam content, said sensor being installed in the upper zone of the tower.

12. The granulation installation as claimed in claim 2, further comprising a dewatering unit with a rotary filtering drum, having a steam collection hood and wherein a first auxiliary evacuation device is connected with its intake end to said steam collection hood.

13. The granulation installation as claimed in claim 1, further comprising an internal hood, which extends into said granulation tank in order to seal said condensation tower against entry of ambient air, and wherein a further auxiliary evacuation device is connected with its intake end to said internal hood.

14. The granulation installation as claimed in claim 1, further comprising a controller device that is connected to operate an obturator device so as to selectively restrict or permit steam and gas passage through said evacuation device.

15. The granulation installation as claimed in claim 1, further comprising a steam-injecting device in the lower zone of the condensation tower.

16. Blast furnace plant comprising a granulation installation as claimed in claim 1.
